(19) United States
(12) Patent Application Publication
(10) Pub. No.: US 2022/0258654 A1
(43) Pub. Date: Aug. 18, 2022

(54) VEHICLE SEAT, IN PARTICULAR MOTOR VEHICLE SEAT

(71) Applicant: Adient US LLC, Plymouth, MI (US)

(72) Inventors: Michelle HERING, Dortmund (DE); Anja SCHAETZMUELLER, Lindlar (DE); Nikola KOHLEN, Koeln (DE); Lars HENNIG, Leichlingen (DE); Uwe SCHULZE, Koeln (DE)

(21) Appl. No.: 17/669,550

(22) Filed: Feb. 11, 2022

(30) Foreign Application Priority Data
Feb. 12, 2021 (DE) 10 2021 103 384.5
Jun. 9, 2021 (DE) 10 2021 114 867.7

(51) Int. Cl. B60N 2/60; B60N 2/64

(52) U.S. Cl. CPC B60N 2/6009; B60N 2/6018; B60N 2/646

(57) ABSTRACT

A motor vehicle seat may have at least one cushion part. The cushion part may have a cover and an additional cover which overlays the cover in sections. A three-dimensional contour of an adaptation region of the cushion part may be reversibly variable. The variability may be provided through an exchangeable additional cushion arranged between the additional cover and the cover. The additional cover may be removed from the cover through a fastener.

### FIELD

The invention relates to a vehicle seat, in particular motor vehicle seat, with at least one cushion part, the cushion part having a cover and an additional cover which overlays the cover in sections, a three-dimensional contour of an adaptation region of the cushion part being reversibly variable, by it being possible for an exchangeable additional cushion to be arranged between the additional cover and the cover.

### BACKGROUND

It is widely known from the prior art to provide cushion parts of vehicle seats with exchangeable seat covers, in order to improve the comfort and the aesthetics of vehicle seats. Here, seat coverings of this type are usually fastened to the seat cushion by a fastening arrangement which is based on non-positive and positively locking connections.

A seat cover which is arranged on a cushion part usually consists of woven or knitted materials or of leather, and makes high requirements of the fitness for use. The seat cover frequently covers only the front side of the vehicle seat, that is to say the use side, whereas materials with less high requirements can be used in the side regions or on the rear side. The seat cover which is provided for the front side can also be used, however, for the bolsters and the rear side.

FR 2 781 733 B1 has disclosed a vehicle seat, the vehicle seat having a cushion with a cushion part and a seat cover. A hook and loop tape and a fleecy tape on the seat cover and the cushion part serve to apply the seat cover to the cushion part on the surface side. By way of a hook and tape connection of this type, the seat cover can be separated from the cushion part simply and can be refastened again to the latter.

JP S59-101 759 U discloses a backrest of a vehicle seat, the backrest having a cushion part with a cover to which there is permanently fastened an additional cover which overlays the cover in sections, wherein the additional cover can be partially detached from the cover but cannot be removed from the cover. The additional cover is securely connected to the cover at its upper edge. In the region of its lower edge, the additional cover has a fastener with which the lower edge of the additional cover can also be connected to the cover. A three-dimensional contour of an adaptation region of the cushion part is reversibly variable, by it being possible for an exchangeable additional cushion to be arranged between the additional cover and the cover. For this purpose, the lower edge of the additional cover is temporarily detached from the cover and the additional cushion is inserted between the cover and the additional cover. The upper edge of the additional cover always remains connected to the cover while this occurs.

### SUMMARY

The invention is based on the problem of improving a vehicle seat of the type mentioned at the outset, in particular of providing a vehicle seat with an elevated comfort and an improved seating experience for an occupant. In addition, it should be easily possible for a user to clean the vehicle seat.

According to the invention, this problem is solved by way of a vehicle seat, in particular motor vehicle seat, with at least one cushion part, the cushion part having a cover and an additional cover which overlays the cover in sections, a three-dimensional contour of an adaptation region of the cushion part being reversibly variable, by it being possible for an exchangeable additional cushion to be arranged between the additional cover and the cover, it being possible for the additional cover to be removed from the cover and the additional cover having a fastener, it being possible for the additional cover to be connected by the fastener to the cover.

A seating experience which is perceptible for an occupant can be individually adapted by way of simple means and a few hand movements by virtue of the fact that the additional cover can be removed from the cover and the additional cover has a fastener, it being possible for the additional cover to be connected by the fastener to the cover. In addition, the additional cover can be easily cleaned, in particular in a domestic washing machine.

The feature that the additional cover can be removed means that the additional cover can be completely detached from the cover and can then be refastened to the cover. The additional cover is preferably reversible and can be completely detached from the cover and refastened to the cover multiple times. By virtue of the fact that the additional cover can be completely removed from the cover, the additional cover can for example be cleaned or washed and then reconnected to the cover. In addition, in the event of damage to the visible cushion surface, the additional cover can be exchanged easily and cost-effectively.

Advantageous refinements which can be used individually or in combination with one another are the subject matter of the subclaims.

The additional cover can be connected by the fastener to the cover. The fastener of the additional cover and the fastener of the cover may together form a zip fastener. A zip fastener is a fastener which is generally familiar to the end user and therefore particularly suitable for connecting the additional cover to the cover. The zip fastener is preferably designed to run around the additional cover. Since a zip fastener cannot run all the way around, the feature “running around” is understood to mean an arrangement in which a beginning and an end of the zip fastener have a producible minimal distance from one another. A circumferential edge of the additional cover is preferably connected to the cover exclusively by the zip fastener.

The vehicle seat can have a seat part. The vehicle seat can have a backrest. The cushion part can be a constituent part of the seat part or of the backrest.

The adaptation region of the cushion part can be arranged in a side region of a seat part. The adaptation region of the cushion part can be arranged in the region of a side bolster of a seat part. The adaptation region of the cushion part can be arranged in a rear region of a seat part. The adaptation region of the cushion part can be arranged in a front region of a seat part. The adaptation region of the cushion part can be arranged in a middle region of a seat part.

The adaptation region of the cushion part can be arranged in a side region of a backrest. The adaptation region of the cushion part can be arranged in the region of a side bolster of a backrest. The adaptation region of the cushion part can be arranged in a lower region of a backrest. The adaptation region of the cushion part can be arranged in an upper region of a backrest. The adaptation region of the cushion part can be arranged in a middle region of a backrest. The adaptation region of the cushion part of a backrest can be arranged in the region of the shoulders of an occupant. The adaptation region of the cushion part can be arranged in a lumbar region of the backrest.

By the additional cushion, a three-dimensional contour of the adaptation region of the cushion part can be adapted reversibly to the requirements of an occupant. The additional cushion is preferably manufactured from an elastic material at least in the adaptation regions. The additional cushion can have an elastic material in sections, in particular in the adaptation regions. As a result, after a removal or exchange of the additional cushion, the additional cover can be adapted again to a contour of the vehicle seat with or without another additional cushion. For example, the vehicle seat can be contoured in a more sporty manner by an additional cushion, in particular by a plurality of additional cushions.

By the additional cushion, a haptic property for an occupant can be capable of being influenced in the adaptation region of the cushion part of the vehicle seat. The additional cushion can have a homogeneous thickness. The additional cushion can have a thickness which increases at least along one direction of extent. The additional cushion can have a thickness which increases towards the side. The additional cushion can have a thickness which increases along a transverse direction. The additional cushion can have a minimum thickness in the range from 3 to 20 mm. The additional cushion can have a maximum thickness in the range from 8 to 30 mm.

The additional cushion can have a fastening in sections. The fastening can be a first half of a hook and loop closure fastener. The fastening can be a hook and loop closure fastener which has a plurality of hooks. As an alternative, the fastening can be a hook and loop closure fastener which has a plurality of loops.

The cover can have, in sections, a matching fastening which cooperates with the fastening of the additional cushion. The additional cover can have, in sections, a matching fastening which cooperates with the fastening of the additional cushion. The matching fastening can be a second half of a hook and loop closure fastener. The matching fastening can be a hook and loop closure fastener which has a plurality of loops. As an alternative, the matching fastening can be a hook and loop closure fastener which has a plurality of hooks.

The additional cushion can be manufactured from a foam, a gel, a gel foam, a woven spacer fabric, a knitted spacer fabric or a spacer. The additional cushion can be a shaped foam part. The additional cushion can have a protective cover. The additional cushion can have a textile protective cover. The additional cushion can be more resistant to harmful UV radiation as a result of the protective cover.

The vehicle seat can have a plurality of additional cushions. The vehicle seat can have a plurality of adaptation regions. In each case precisely one additional cushion can be arranged in the plurality of adaptation regions of the vehicle seat. Different additional cushions can be arranged in the plurality of adaptation regions of the vehicle seat. The plurality of additional cushions can be arranged symmetrically with respect to a centre plane which is oriented perpendicularly with respect to the transverse axis. The additional cushions can be of mirror-symmetrical configuration in pairs. The additional cushions can be of different configuration. In particular, an additional cushion of a tunnel-side side bolster of the seat part or of the backrest can be of higher configuration than an additional cushion of a door-side side bolster of the seat part or of the backrest.

In summary and expressed in different words, the newly obtained individualizing capability of the vehicle seat can then, furthermore, influence a subjective seating comfort. A more sporty variant with correspondingly more lateral support can then be created from what is known as a basic seat by way of corresponding adaptations by one or more additional cushions, it being possible for the personal feelings of an occupant to be taken into consideration and designed individually.

The fact that the additional cover can be removed and reinserted by a vehicle user himself/herself provides the possibility of positioning further additional cushions in part regions of the vehicle seat. These additional cushions can be manufactured from foam, gel, a woven spacer fabric or knitted spacer fabric or other materials, and can be positioned, protected by way of a pocket made from textile, directly between the (technical) cover and the removable additional cover.

### DESCRIPTION OF THE FIGURES

In the following text, the invention is described in greater detail on the basis of one advantageous exemplary embodiment which is shown in the figures. The invention is not restricted to this exemplary embodiment, however. In the figures:

FIG. 1 shows a vehicle seat according to the invention with cushion parts and additional cushions, without an additional cover,

FIG. 2 shows a top view of a seat part of the vehicle seat from FIG. 1,

FIG. 3 shows details of a side bolster of the seat part from FIG. 2,

FIG. 4 shows an additional cushion,

FIG. 5 shows details of the side bolster from FIG. 3 with the inserted additional cushion from FIG. 4,

FIG. 6 shows a view from the front of the side bolster with the additional cushion from FIG. 5,

FIG. 7 shows a view from the front of the side bolster with the additional cushion and an additional cover which is fastened partially to the cover, and

FIG. 8 shows a view from the front of the seat part from FIG. 2 after the mounting of the additional cushions and a completely fastened additional cover.

### DETAILED DESCRIPTION

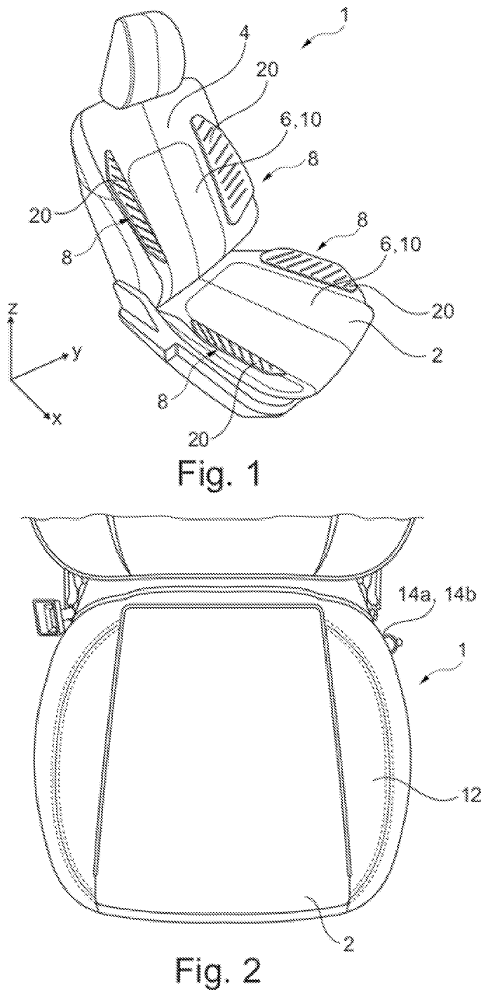

A vehicle seat 1 which is shown diagrammatically in FIG. 1 will be described in the following text with the use of three spatial directions which run perpendicularly with respect to one another. A longitudinal direction x runs largely horizontally, in the case of a vehicle seat 1 which is installed in a vehicle, and preferably parallel to a vehicle longitudinal direction which corresponds to the usual driving direction of the vehicle. A transverse direction y which runs perpendicularly with respect to the longitudinal direction x is likewise oriented horizontally in the vehicle, and runs parallel to a vehicle transverse direction. A vertical direction z runs perpendicularly with respect to the longitudinal direction x and perpendicularly with respect to the transverse direction y. In the case of a vehicle seat 1 which is installed in the vehicle, the vertical direction z runs parallel to the vehicle vertical axis.

The positional specifications and directional specifications which are used, such as for example front, rear, top and bottom, relate to a viewing direction of an occupant seated in the vehicle seat 1 in a normal seating position, the vehicle seat 1 being installed in the vehicle, in a use position suitable for passenger conveying with an upright backrest 4 and, as customary, oriented in the driving direction. The vehicle seat 1 can also be installed, however, in a different orientation, for example transversely with respect to the driving direction.

The vehicle seat 1 shown in FIG. 1 for a motor vehicle has a seat part 2 and a backrest 4, the inclination of which can be adjusted relative to the seat part 2. An inclination of the backrest 4 can be capable of being adjusted, for example, by a latching fitting or geared fitting.

The seat part 2 and the backrest 4 of the vehicle seat 1 in each case have a cushion part 6. The cushion part 6 of the seat part 2 and of the backrest 4 is in each case provided with at least one cover 10 which spans the respective cushion part 6. Furthermore, an additional cover 12 which overlays the cover 10 in sections is provided. In the present case, the additional cover 12 extends over the entire width of the seat part 2 and of the backrest 4.

In the present case, the vehicle seat 1 has two cushion parts 6 with a plurality of adaptation regions 8. In the adaptation regions 8, at least one exchangeable additional cushion 20 can be arranged between the additional cover 12 and the cover 10. As a result, the three-dimensional contour of the adaptation regions 8 can be changed.

In the present case, the vehicle seat 1 has a plurality of additional cushions 20. In the present case, the plurality of additional cushions 20 are arranged in pairs in a mirror-symmetrical manner with respect to a centre plane which is oriented perpendicularly with respect to the transverse axis y.

Two of the adaptation regions 8 are arranged in a side region of the cushion part 6 of the seat part 2, in the present case in a region of a side bolster of the seat part 2. Two further adaptation regions 8 are arranged in a side region of the cushion part 6 of the backrest 4, in the present case in the region of a side bolster of the backrest 4.

FIG. 2 shows a view from above of the seat part 2 of the vehicle seat 1. The additional cover 12 has a first fastener 14a. In order to fasten the additional cover 12 to the cover 10, the cover 10 has a second fastener 14b which cooperates with the first fastener 14a. In the present case, the two fastener 14a, 14b together form a zip fastener.

In the present case, the zip fastener runs around, in particular runs completely around, the seat part 2. The additional cover 12 can be fastened to the cover 10, in particular over the full periphery, by a first fastener 14a in operative connection with the second fastener 14b.

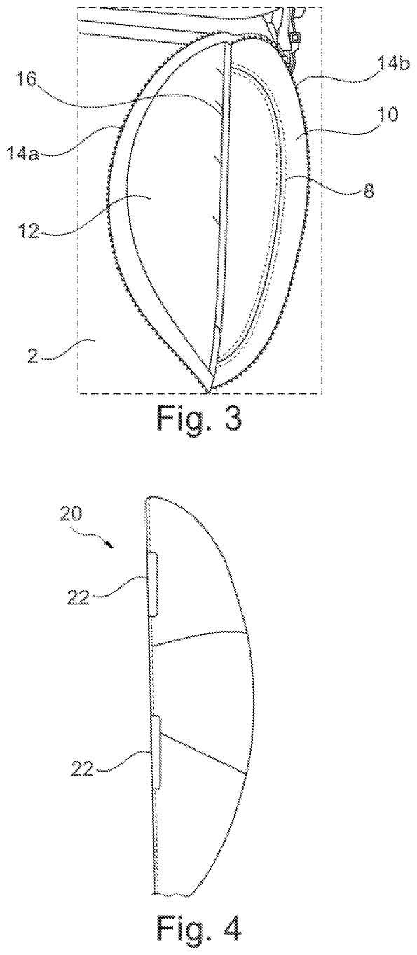

FIG. 3 shows the additional cover 12 in a state with fastener 14a, 14b which are separated in each case from one another, the additional cover 12 being folded over in sections.

FIG. 4 shows the additional cushion 20 with a protective cover. The protective cover preferably surrounds a foam part. The additional cushion 20 has a fastening 22 in sections. In the present case, the fastening 22 is configured as a first half of a hook and loop closure fastener.

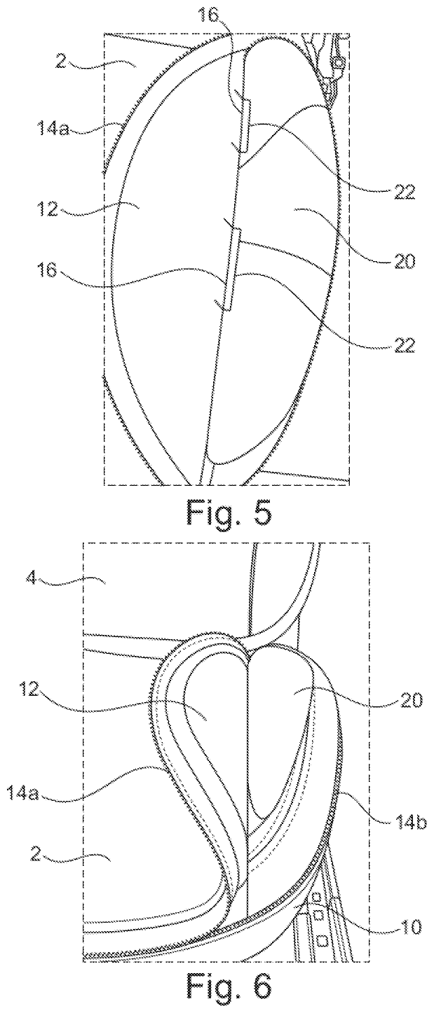

FIGS. 5 and 6 show the side bolster of the seat part 2 with the inserted additional cushion 20. The additional cover 12 has, in sections, a matching fastening 16 which cooperates with the fastening 22 of the additional cushion 20. In the present case, the matching fastening 16 is configured as a second half of the hook and loop closure fastener.

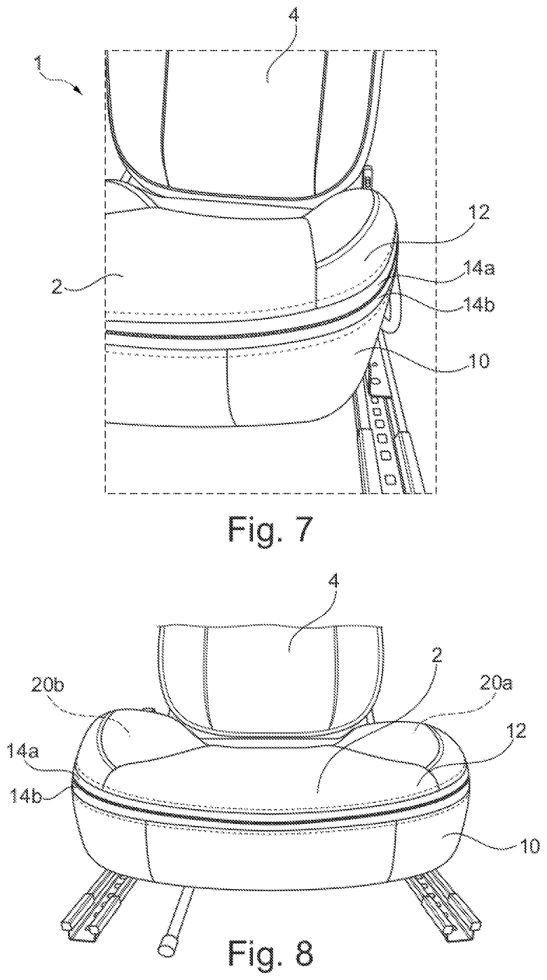

FIGS. 7 and 8 show different views from the front of the seat part 2 and the side bolster with the additional cushion 20 and the additional cover 12. The illustrated state exists, for example, after the mounting of the additional cushions 20 when the fastener 14a, 14b of the additional cover 12 and of the cover 10 are connected to one another again.

In the present case, the additional cushions 20a, 20b which are introduced into the vehicle seat 1 are of different configuration by way of example. In particular, the additional cushion 20b of the tunnel-side (in FIG. 8) side bolster of the seat part 2 has a higher thickness than the opposite additional cushion 20a of the door-side side bolster. An adaptation of the door-side side bolster with a comparatively thinner additional cushion 20a or even completely without an additional cushion 20a facilitates entry into the vehicle seat 1 or exit from the vehicle seat 1 for the occupant; whereas the lateral support in the direction of the tunnel side of the seat part 2 is increased by way of an adaptation of the tunnel-side side bolster with a comparatively thicker additional cushion 20b.

The features which are disclosed in the preceding description, the claims and the drawings can be of significance both individually and in combination for the implementation of the invention in its various refinements, in so far as this is covered by the wording of the independent claims.

### LIST OF REFERENCE SIGNS

1 Vehicle seat
2 Seat part
4 Backrest
6 Cushion part
8 Adaptation region
10 Cover
12 Additional cover
14a Fastener
14b Fastener
16 Matching fastening
20 Additional cushion
20a Additional cushion
20b Additional cushion
22 Fastening

What is claimed is:

1. A motor vehicle seat, comprising:
at least one cushion part, the cushion part having a cover and an additional cover which overlays the cover in sections, wherein a three-dimensional contour of an adaptation region of the cushion part being reversibly variable, wherein an exchangeable additional cushion is selectively arranged between the additional cover and the cover,
wherein the additional cover can be removed from the cover and the additional cover has a first fastener, wherein the additional cover is selectively connected by the first fastener to the cover.

2. The vehicle seat according to claim 1, wherein the additional cover is connected by the first fastener to a second fastener of the cover.

3. The vehicle seat according to claim 2, wherein the first fastener of the additional cover and the second fastener of the cover together form a zip fastener.

4. The vehicle seat according to claim 3, wherein the zip fastener extends around the additional cover.

5. The vehicle seat according to claim 1, wherein the additional cushion has a homogeneous thickness.

6. The vehicle seat according to claim 1, wherein the additional cushion has a thickness which increases at least along one direction of extent.

7. The vehicle seat according to claim 1, wherein the additional cushion has a minimum thickness in the range from 3 to 20 mm.

8. The vehicle seat according to claim 1, wherein the additional cushion has a maximum thickness in the range from 8 to 30 mm.

9. The vehicle seat according to claim 1, wherein the additional cushion has a fastening.

10. The vehicle seat according to claim 9, wherein the cover or the additional cover have a matching fastening which cooperates with the fastening of the additional cushion.

11. The vehicle seat according to claim 9, wherein the fastening of the additional cushion is a first half of a hook and loop closure fastener.

12. The vehicle seat according to claim 11, wherein the cooperating matching fastening of the cover is a second half of the hook and loop closure fastener.

13. The vehicle seat according to claim 1, wherein the additional cushion is manufactured from a foam, a gel, a gel foam, a woven spacer fabric, a knitted spacer fabric or a spacer.

14. The vehicle seat according to claim 1, wherein at least one additional cushion is arranged in a plurality of adaptation regions of the vehicle seat.

15. The vehicle seat according to claim 14, wherein the additional cushions are different from one another and are arranged in the plurality of adaptation regions of the vehicle seat.
